(19) United States
(12) Patent Application Publication
(10) Pub. No.: US 2012/0084196 A1
(43) Pub. Date: Apr. 5, 2012

(54) Process and System for Producing Default and Prepayment Risk Indices

(76) Inventor: Dennis Capozza, Ann Arbor, MI (US)

(21) Appl. No.: 12/896,408

(22) Filed: Oct. 1, 2010

(51) Int. Cl. G06Q 40/00

(52) U.S. Cl. 705/38

(57) ABSTRACT

A process, system and program for generating an index of loan default and prepayment risk for a region. This disclosure relates to analytical financial tools including a process, system and program for producing indices for loan default and prepayment risk by local region and origination date. A scoring system can generate an index number for local geographic risk scores for lending analysis including with the use of data by a statistical model of loan defaults and prepayments.

### FIELD OF THE DISCLOSURE

This disclosure relates to analytical financial tools including a process and system for producing loan default and prepayment risk indices by region and origination date. More specifically, the processes and systems relate to a scoring system generating an index number for local geographic risk scores for lending analysis.

### BACKGROUND

Financial and lending institutions use mathematical modeling and data analysis for financial problem solving. Such institutions may use bureau credit scores in an analysis of potential default or prepayment by individuals. Bureau scores have been in use in the lending industry since 1958, and have enabled technical progress and innovation in loan origination, pricing and valuation, benefiting both borrowers and lenders.

Research shows, however, that many additional factors other than the borrower's willingness to pay (bureau score) affect loan performance. While valuable, a bureau score does not give the full picture. To complete the picture for lenders, investors and regulators, consumer loan scoring models need to account for the powerful effect of local economic conditions on loan performance.

Existing financial models are better at looking back than forward, are more qualitative than quantitative in scope, and have difficulties gauging the impact of local business conditions. The latter can include such “site specific” factors as home starts, home mortgage debt, repayment rates on all types of loans, business startups and defaults, labor supply and wages, intrinsic industry fortunes, and public policy with respect to tax. The situation can get even stickier with nonprime lending, the higher risk and reward type of lending with residuals derived from such loans carrying a much higher “mistake” potential than traditional bank lending, often as great as 30 percent to 40 percent of exposure. This is the New Hope and New Ideas lending that carries New Risks.

U.S. Publication 2007/0050287 discloses a method for structuring a new loan including receiving borrower information related to the new loan; receiving performance information related to funded loans; and determining a new loan risk for the new loan based on the borrower information and the performance information. The borrower information may include a credit score. The concept of using economic data to the postal (ZIP) region is disclosed in paragraph [0014]. This method could be improved with an easy-to-use scoring system.

A need exists for a process and system to generate a scoring system creating index numbers as local geographic risk scores.

### SUMMARY

The present disclosure provides simple metrics for the economic risks of default and prepayment at the local/Zip Code level. Like a bureau score, such indices can be easily incorporated into financial analytics. Disclosed local economic indices make it easy to incorporate local economic conditions into scoring and modeling.

A system that arrives at a score/result using comprehensive data may include a computer program for evaluating loans and scoring local economic risk. The computer program including an input module for using data for a local geographic region; a statistical model of defaults and prepayments; an estimator of defaults and prepayments for the local geographic region; and an output mode for an index number of loan default and prepayment risk for the local geographic region. The computer program may have the input module adapted for entering geography-specific data into a database of the computer and simple search data may be entered to obtain a score of risk.

A process of scoring local economic risk adapted for use with evaluating a loan may include the steps of entering geography-specific data into a computer, using a statistical model of loan defaults and prepayments, and generating an index of loan default and prepayment risk for a local geographic region. The geography-specific data is preferably for the local region, such as by Zip Code, and the index of loan default and prepayment risk is typically for an origination date. Estimates of life-of-loan defaults and prepayments can be generated for the region and origination date, including incorporating current and forecast value of geographic-specific data.

Studies indicate that traditional underwriting criteria like loan-to-value and credit scores account for only half of loan performance. With the disclosed system and indices, users can begin accounting for the most overlooked side of performance: local economic conditions. Such analysis and modeling can help businesses make better lending and investing decisions. Lenders, investors, and regulators in the prime, non-prime and subprime markets can easily improve existing underwriting and portfolio management to account for local conditions.

The disclosed indices can be added as easily as a bureau score to existing financial methodology. The disclosed system allows the lending and financial services industries to:
Easily adjust current scoring and loan valuation to integrate local economic risks into an analysis
Accurately predict the impact of the local economic environment on loan default and prepayment
Evaluate the local or Zip Code level economic risks for a loan both at the time of origination and during each month the loan is active
Use the power of analysis of local economic conditions via web access
Avoid the consequences of credit and economic cycles, with proper positioning during both recession and recovery periods.

The system/process/product is more comprehensive than the prior art and can be modeled to the local/Zip Code level for insurers, investors, risk managers and underwriters to analyze a location and evaluate deals using a score. Data may be input and uniquely extracted from various sources in this process.

### BRIEF DESCRIPTION OF THE DRAWINGS

The above-mentioned and other features of this disclosure and the manner of obtaining them will become more apparent, and the disclosure itself will be best understood by reference to the following descriptions of systems and processes taken in conjunction with the accompanying figures, which are given as non-limiting examples only, in which:

FIG. 1 shows a Zip Score fitting into larger analytics, and

FIG. 2 shows a flow chart of a process to arrive at indices of default and prepayment risk.

The exemplifications set out herein illustrate embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiments in different forms, the drawings show, and herein described in detail, embodiments with the understanding that the present descriptions are to be considered exemplifications of the principles of the disclosure and are not intended to be exhaustive or to limit the disclosure to the details of processes, construction and the arrangements of components set forth in the following description or illustrated in the figures.

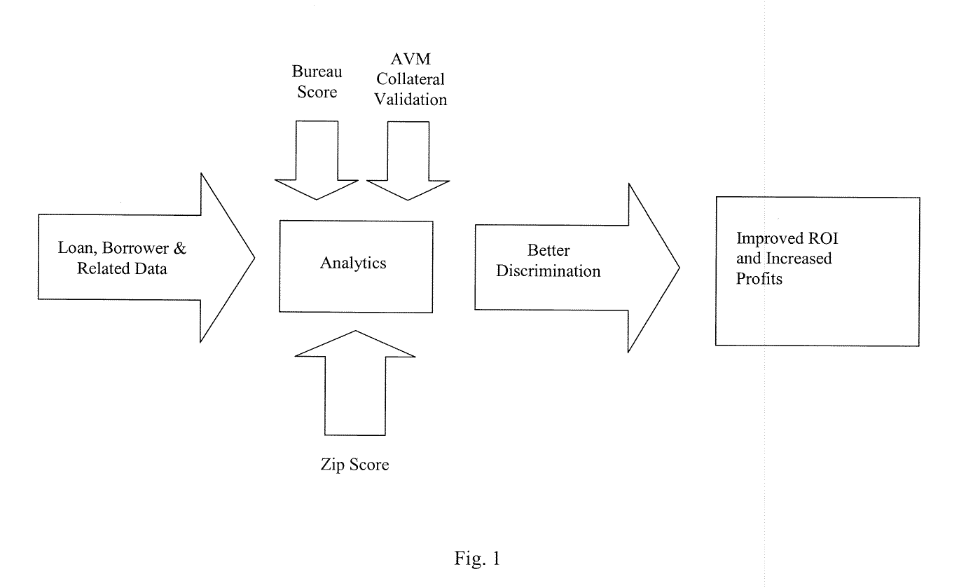

FIG. 1 shows how an index, such as a Zip Score, might fit into larger analytics. Zip Score indicates a variety of indices of default and prepayment risk for a particular region. In addition to bureau scores, AVM collateral validations, and Loan, Borrower & Related Data, a Zip Score can be incorporated into analytics for better discrimination for improved return on investment and increased profits related to loan products.

Certain loan portfolio analysis software can provide analytical techniques to lenders. The system allows lenders to extract the implications of existing data and then project forward to arrive at a lending strategy, preferably instead of using past results as a benchmark for the future. Thus, the system evaluates not only borrower credit but also the product structure, the collateral and local economic conditions. Existing lending markets and conditions can be accounted for in the analytics.

The result can be a valuable loan metric, such as an index or score, for evaluating the economic risks of default and prepayment at the local region, such as Zip Code level. Zip Code has a special meaning as a postal code for local areas, and as used herein could equate to other designations of similar local regions.

Such Zip Code level indices of default and prepayment risks arising from the local economic, demographic, political, topographic and legal environments are built and tested on millions of loan records, which have been validated carefully over the last 15 years. A demonstrable track record has been proven in practice at Fitch Ratings and other financial firms. With better tools, all participants in the credit value chain—from lenders to borrowers, regulators, insurers and investors—can reduce risk, enhance portfolio returns, and improve access to credit.

This scoring process can be as simple as entering a Zip Code and a loan origination date, and receiving a default and prepayment risk index instantly. The indices build in both borrower and collateral performance predictions to predict risk years earlier than any other measure. With analysis of factors such as future house price appreciation, income and employment growth, local market supply and demand, geographic constraints, the effects of the local legal environment all build into one quick index number. This gives confidence in decisions at origination, during securitization or restructuring, and when hedging cash flows.

A computer program for evaluating loans and scoring local economic risk may include an input module for using data for a local geographic region; a statistical model of defaults and prepayments; an estimator of defaults and prepayments for the local geographic region; and an output mode for an index number of loan default and prepayment risk for the local geographic region. The computer program may have the input module adapted for entering geography-specific data into a database of the computer and simple search data may be entered. While the index is preferred over the internet for analysis, the computer program can be adapted for printing the index number on a piece of paper with a printer.

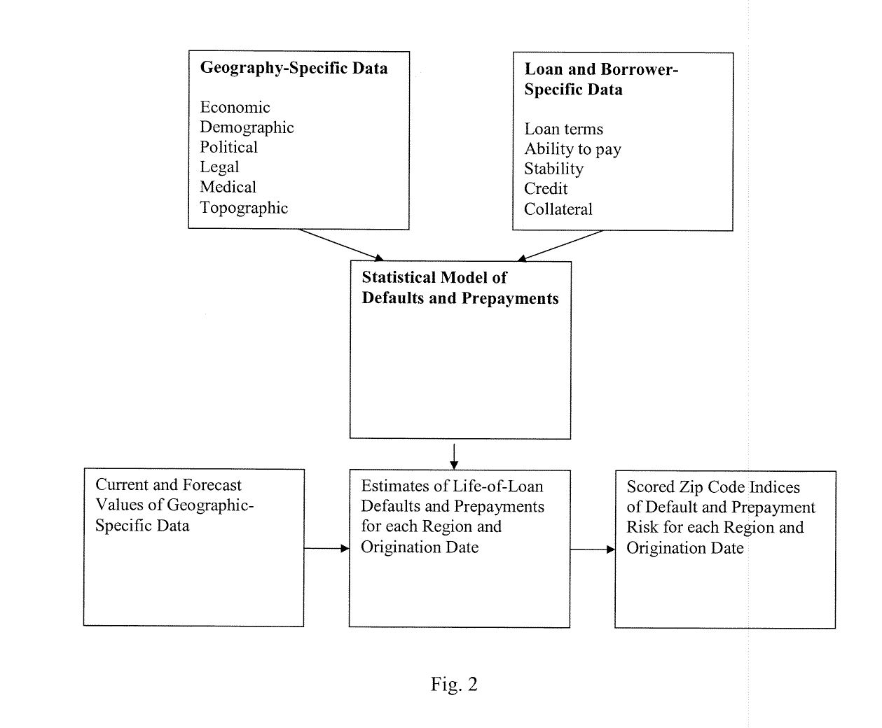

FIG. 2 shows a flow chart of a process to arrive at indices of default and prepayment risk. The flow chart shows the steps of how data comes into a statistical model. Loan and Borrower specific data and Geography-specific data can be incorporated into a statistical model of defaults and prepayment. Loan and Borrower specific data may include loan terms, ability to pay, stability, credit and collateral, and geography-specific data may include economic, demographic, political, legal, medical and topographic data. The statistical model can derive estimates of life-of-loan defaults and prepayments for each region and origination date. Current and forecast values of geographic-specific data can be incorporated into estimates of life-of-loan defaults and prepayments. This process can provide scored local/Zip Code indices of defaults and prepayment risk for each region and origination date.

### The Geographic Risk Indices:

The indices of local default and prepayment risks are ideally created from estimates of statistical equations for prepayment and default using loan level data for loans including mortgage and auto loans. The estimated equations are of the form:

dₜᵣ^{τsi}=a(s)e^{bX(r,t)+cY}^{ⁱ}^{(r,τ)+dG(r)} (1)

pₜᵣ^{τsi}=a(s)e^{bX(r,t)+cY}^{ⁱ}^{(r,τ)+dG(r)} (2)

where d and p are probabilities during a quarter of the loan defaulting (d) or prepaying (p) on a loan to borrower i, originated at time Tin region r that is s periods old and is observed at time t, and

X(r,t) is a vector of time varying covariates that describe the economy, the demographics, the legal, the political, the medical and the topographic environment in region r at time t;

Yⁱ(r,τ) is a vector of characteristics of the loans and the borrowers in region r at time of origination;

G(r) is a vector of variables that are not time varying and describe region r;

a, b, c and d are vectors of coefficients.

The estimates of these two equations use current and lagged values of X(r,t).

The model then uses current and forecast data of X(r,t) to estimate balance-weighted defaults and prepayments over time in each region for a representative loan, holding the Y variables (loan and borrower characteristics) constant. The probability of defaulting on a loan originated at time t in region r is estimated from the summation of the balance-weighted unconditional default probabilities over the life of the loan.

Yearly values of the index are relative to a baseline year. Increases in the index correspond to increases in the probability of default or prepayment. The indices provide a panel of metrics for the effect of regional geographic-specific conditions on the performance of loans over time and regions.

Numerous factors can be incorporated into the scores, including:
Local economic variables like income, employment, and unemployment
Local/Zip Code level demographics like population growth and distribution
Forecasts of future collateral values with quarterly updates
Local legal environmental factors like recourse, judicial foreclosure, and predatory lending laws
Local political variables like property taxes and growth controls
Local topography, such as coastal, that may affect loan performance
Local morbidity variables, such as obesity.

A detailed set of instructions for accomplishing such process and arriving at an index number can be expressed in machine language as instructions for a computer or a language suitable for input into a computer. The steps of the process can be performed on a computer, and it is preferred that the process can be performed in conjunction with the internet.

Financial institutions and lenders can control risks through statistical and econometric modeling, practical application of the latest financial theories, and extensive regional economic databases and analysis in such key areas as: corporate and portfolio risk management; loan marketing; product pricing and structuring; and loan underwriting and valuation.

This disclosure has been described as having exemplary embodiments and is intended to cover any variations, uses, or adaptations using its general principles. It is envisioned that those skilled in the art may devise various modifications and equivalents without departing from the spirit and scope of the disclosure as recited in the following claims. Further, this disclosure is intended to cover such variations from the present disclosure as come within the known or customary practice within the art to which it pertains.

What is claimed is:

1. A computer program executable on a computer for evaluating loans and scoring local economic risk, the computer program including:
a module for using data for a local geographic region;
a statistical model of defaults and prepayments;
an estimator of defaults and prepayments for the local geographic region; and
an output mode for an index number of loan default and prepayment risk for the local geographic region.

2. The computer program of claim 1 including the module adapted for entering geography-specific data into a database of the computer.

3. The computer program of claim 1 adapted for printing the index number on a piece of paper with a printer.

4. The computer program of claim 1 wherein the statistical model includes the equations:
dₜᵣ^{τsi}=a(s)e^{bX(r,t)+cY}^{ⁱ}^{(r,τ)+dG(r)} (1)
pₜᵣ^{τsi}=a(s)e^{bX(r,t)+cY}^{ⁱ}^{(r,τ)+dG(r)} (2)
where d and p are probabilities during a quarter of the loan defaulting (d) or prepaying (p) on a loan to borrower i, originated at time r in region r that is s periods old and is observed at time t, and
X(r,t) is a vector of time varying covariates that describe economy, demographics, and legal, political, medical and topographic environment in region r at time t;
Yⁱ(r,τ) is a vector of characteristics of loans and borrowers in region r at time of origination;
G(r) is a vector of variables that are not time varying and describe region r;
a, b, c and d are vectors of coefficients.

5. A process of scoring local economic risk adapted for use with evaluating a loan including the steps of:
entering geography-specific data into a computer,
using a statistical model of loan defaults and prepayments, and
generating an index of loan default and prepayment risk for a local region.

6. The process of claim 5 wherein the statistical model includes:
dₜᵣ^{τsi}=a(s)e^{bX(r,t)+cY}^{ⁱ}^{(r,τ)+dG(r)} (1)
pₜᵣ^{τsi}=a(s)e^{bX(r,t)+cY}^{ⁱ}^{(r,τ)+dG(r)} (2)
where d and p are probabilities during a quarter of the loan defaulting (d) or prepaying (p) on a loan to borrower i, originated at time Tin region r that is s periods old and is observed at time t , and
X(r,t) is a vector of time varying covariates that describe economy, demographics, and legal, political, medical and topographic environment in region r at time t;
Yⁱ(r,τ) is a vector of characteristics of loans and borrowers in region r at time of origination;
G(r) is a vector of variables that are not time varying and describe region r;
a, b, c and d are vectors of coefficients.

7. The process of claim 5 wherein the computer is loaded with loan portfolio analysis software.

8. The process of claim 5 wherein the geography-specific data is for the local region and the index of loan default and prepayment risk is for an origination date.

9. The process of claim 5 wherein the local region is based on Zip Code.

10. The process of claim 5 wherein the geography-specific data includes economic, demographic, political, legal, medical and topographic data.

11. The process of claim 5 including a step of deriving an estimate of life-of-loan defaults and prepayments for the region and origination date.

12. The process of claim 11 including a step of incorporating current and forecast value of geographic-specific data into the estimate of life-of-loan defaults and prepayments.

13. The process of claim 5 including a step of entering a Zip Code and a loan origination date.
